(19) United States
(12) Patent Application Publication
(10) Pub. No.: US 2007/0180178 A1
(43) Pub. Date: Aug. 2, 2007

(54) Information processor, information processing method, and medium

(75) Inventors: Shigeaki Oura, Kawasaki (JP); Kenji Sakamaki, Kawasaki (JP); Tetsuya Takeda, Kawasaki (JP); Takeshi Miyamae, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/727,631

(22) Filed: Mar. 27, 2007

Related U.S. Application Data
(62) Division of application No. 10/058,991, filed on Jan. 30, 2002.

(30) Foreign Application Priority Data
Aug. 4, 1999 (JP) PCT/JP99/04216

(51) Int. Cl. G06F 13/00

(52) U.S. Cl. 710/303

(57) ABSTRACT

A processing method of an information processor for connecting an external device with a main body of the information processor. The processing method also performs processing of an application program with respect to the external device. The processing method includes connecting the external device to the main body. The processing method also includes determining whether the connected external device has been previously connected with the main body of the information processor.

### CROSS-REFERENCE TO RELATED APPLICATIONS

This application is a divisional application of application Ser. No. 10/058,991, filed Jan. 30, 2002, now pending. This application claims the benefit of Japanese Patent Application No. PCT/JP99/04216, filed Aug. 4, 1999 in the Japanese Patent Office, the disclosure of which is incorporated herein by reference.

### BACKGROUND OF THE INVENTION

1. Field of the Invention

The present invention relates to a technique, which is effective by applying to a peripheral equipment control technique of a computer for recognizing a physical unit (device) by cooperating with an operating system.

2. Description of the Related Art

In an information processor such as a personal computer, when an application program for communication is started, the application program executes communication with the outside through a communication line via a modem connected with a main body of the computer.

That is, in the above-mentioned communication program, it is assumed that the modem is connected with the main body of the computer. However, in a case where a physical unit such as the modem which is required for the application is not fitted with after starting the application, the application can not perform planned processing (communication processing etc.).

In this case, the application causes a processing error. When an operator notices this error, he or she has to terminate the application temporarily, connect the physical unit required for the application with the main body of the computer, and then restart the application program.

Even though it is the operator who is to be blamed for not having connected the required physical unit, the application program has to be restarted, and in some cases, a device driver program has to be additionally installed so that the physical unit can perform access through the operating system. As a result, there are required complicated procedures.

The present invention has been made in view of the above problem. A technical object of the present invention consists in that, even in a case where the physical unit required for the application is not connected with the main body of the computer at the time of starting the application, the application program processing is temporarily suspended and the physical unit is fitted with during the suspension state, whereby the application becomes in a state capable of using the physical unit without restarting the application.

### SUMMARY OF THE INVENTION

In an information processor for connecting an external device with a main body of the processor and performing processing with respect to the external device, the present invention starts processing on the main body of the processor and thereafter judges whether the external device associated with the processing is fitted with or not. When the external device is not fitted with, the processing is interrupted. When recognizing that the external device is fitted with, the interrupted processing is restarted.

### BRIEF DESCRIPTION OF THE DRAWINGS

Other objects, features and advantages of the present invention will become more apparent from the following detailed description when read in conjunction with the accompanying drawings of which:

FIG. 1 is a functional block diagram showing an embodiment of the present invention;

FIG. 2 is an outer configuration view showing a connection method between a personal computer and a CD player according to the embodiment of the present invention;

FIG. 3 is a diagram showing processing flow of the embodiment of the present invention;

FIG. 4 is a diagram showing processing flow of another embodiment of the present invention; and

FIG. 5 are explanatory diagrams showing display contents displayed on a display unit in the embodiment.

### DETAILED DESCRIPTION OF THE PREFERRED EMBODIMENTS

The present invention will be described below with reference to the drawings.

### Embodiment 1

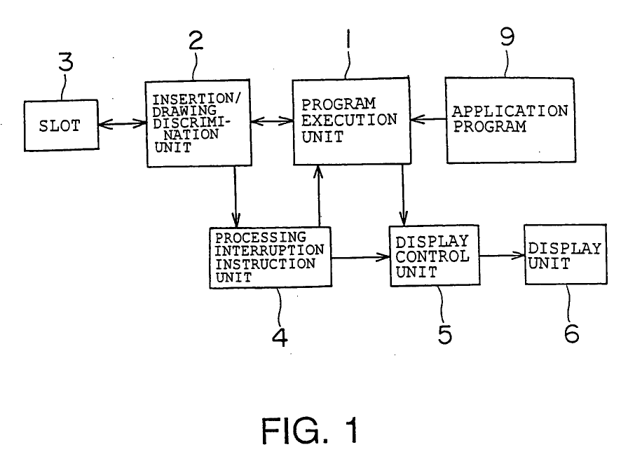

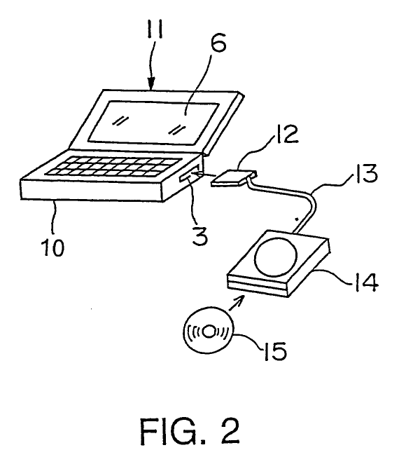

FIG. 1 is a functional block diagram of an embodiment. Also, FIG. 2 is an outer configuration view of a system, in which a CD drive is connected with a notebook-sized personal computer through a card interface according to the present invention.

A notebook-sized personal computer 11 of the present invention is provided with a keyboard 10 and a display unit 6 composed of a liquid crystal color display, and there is provided a slot 3 at a side portion thereof.

A CD drive 14 is connected with an interface card 12 via a cable 13. When this interface card 12 is inserted into the card slot 3 of the personal computer 11, the personal computer 11 is physically connected with the CD drive 14. This CD drive 14 is configured so that a CD-ROM or a music CD and the like are mounted.

Also, on the personal computer 11, Windows 95 or Windows 98 of Microsoft Corporation is installed as an operating system (OS), and various kinds of application programs 9 (here, a CD player program) are executable on this OS.

FIG. 1 shows a function of the present embodiment using a block structure. In the figure, an insertion/drawing discrimination unit 2 keeps monitoring a state of the card slot 3. The insertion/drawing discrimination unit 2 is capable of discriminating whether the card slot 3 is in an open state or not and when the card is inserted, discriminating classification of the card.

A program execution unit 1 is a unit for executing the application program 9 installed on the OS.

A processing interruption instruction unit 4 includes a function for instructing program interruption or program restart with respect to the program execution unit 1, based on a determination result of the insertion/drawing discrimination unit 2.

A display control unit 5 includes a function for outputting a display which stimulates an operator to perform the processing on the display unit 6, in accordance with an instruction from the program execution unit 1 and the processing interruption instruction unit 4.

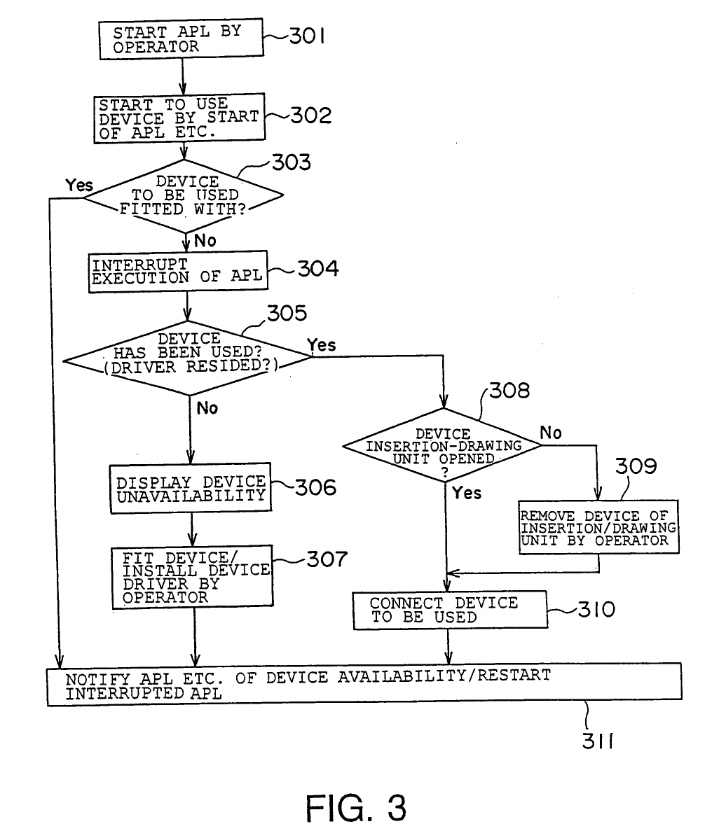

Next, processing procedures will be specifically described with reference to FIG. 3.

The operator starts a CD player program that is an application program on an interface provided by the OS (step 301, 302). Here, for example, an icon, which is displayed on the display unit 6 and symbolizes the application, is designated by a pointing device such as a mouse, and the application is started.

Next, the insertion/drawing discrimination unit 2 monitors the card slot 3 and judges whether the interface card 12 and the CD drive 14 are in a connection state or not (303).

When the insertion/drawing discrimination unit 2 determines that the CD drive 14 is not connected, the processing interruption instruction unit 4 is notified of the determination. Then the processing interruption instruction unit 4 makes the program execution unit 1 interrupt the execution of the application program 9 (304).

On the other hand, in the above-mentioned step 303, when the insertion/drawing discrimination unit 2 determines that the CD drive 14 is in the connection state, the insertion/drawing discrimination unit 2 notifies the program execution unit 1 that the CD drive 14 is available (311). Thereafter, the CD player program is executed and the music CD 15 mounted on the drive 14 is replayed.

On the other hand, in the above-mentioned step 303, at the time of being in a state that the CD drive 14 is not available, for example, when the interface card 12 is not inserted into the card slot 3, the processing interruption instruction unit 4 which has received this notification makes the program execution unit 1 interrupt the execution of the application program 9 (304).

Then, the processing interruption instruction unit 4 determines whether the personal computer 11 has ever used the CD drive 14 and the interface card 12 or not (305). This specifically implies determination as to whether a device driver program resides on the OS or not. That is, when the CD drive 14 has been used in the past, a possibility that the device driver program is loaded on the OS is high. Therefore, the CD drive 14 becomes in an available state by physically connecting the CD drive 14.

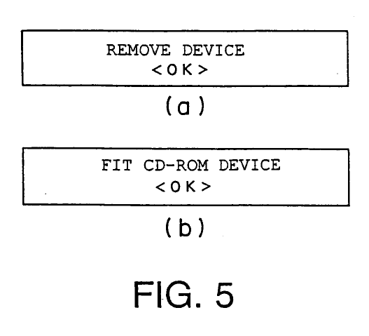

Therefore, in the above determination step 304, when it is determined that the CD drive 14 has been used in the past, that is, in the case where the device driver program has been already installed, the processing interruption instruction unit 4 determines whether the card slot 3 is in an open state or not through the insertion/drawing discrimination unit 2 (308). Here, in a case where other card has already been inserted into the card slot 3, a display such as “Remove device.” as shown in FIG. 5(a) is displayed on the display unit 6 via the display control unit 5.

Then, when recognizing that the card having been inserted is removed through the insertion/drawing discrimination unit 2, the processing interruption instruction unit 4 performs a display such as “Fit CD-ROM device.” as shown in FIG. 5(b) on the display unit 6 through the display control unit 5, and stimulates the operator to insert the interface card 12 into the card slot 3.

As described above, when the interface card 12 is inserted into the card slot 3 (309, 310), the processing interruption instruction unit 4 notifies the program execution unit 1 that the CD drive 14 is available. When the program execution unit 1 receives this notification, the execution of the program 9 (CD player program) is restarted (311).

On the other hand, in step 305, when the connected interface card 12 or the connected CD drive 14 is a device which has not been used in the past, a display indicating to the effect that the interface card 12 or the CD drive 14 is not available is displayed on the display unit 6 through the display control unit 5, and the operator is stimulated to install the device driver program at the same time (306, 307). Then, when completing the installation of these required driver program, the processing interruption instruction unit 4 notifies the program execution unit 1 that the CD drive 14 becomes in an available state. Therefore, the program execution unit 1 restarts the execution of the program 9 (311).

### Embodiment 2

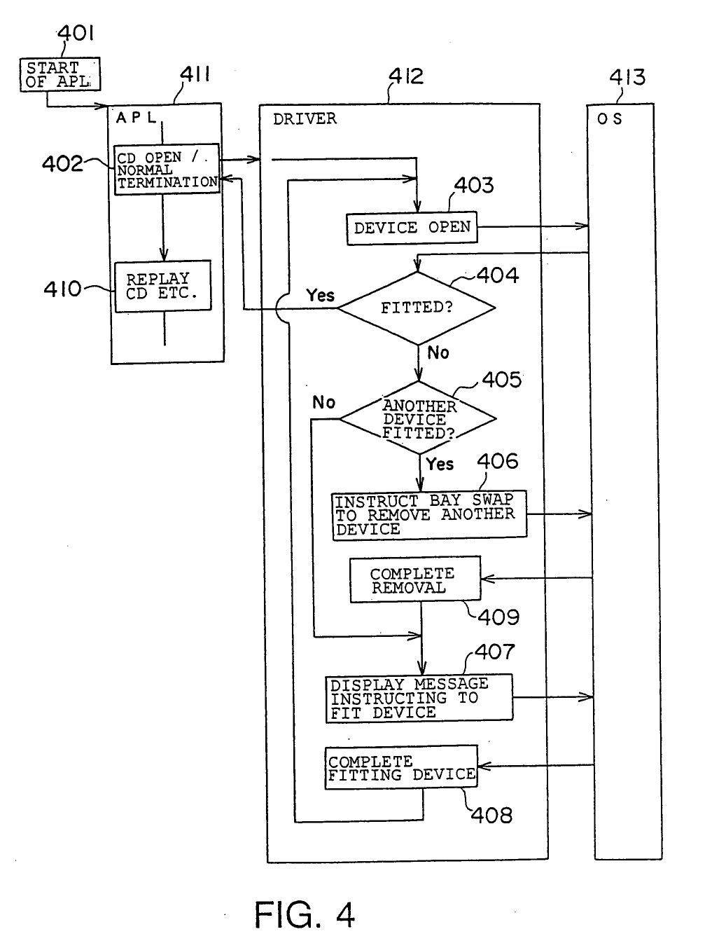

FIG. 4 is a processing block diagram showing an example of realizing the present invention by the device driver program.

The present invention may be realized by incorporating a stop function of the application program in the device driver program itself.

When the operator designates an icon, which is displayed on the display unit 6 and symbolizes the CD player program, by using a pointing device such as a mouse (401), the CD player program is started.

When a CD player program 411 issues an access command to the CD drive 14 (402), a device drive program 412 notifies an operating system (OS) 413 of open of the devices (interface card 12 and CD drive 14) (403). Then, when recognizing that the devices have been fitted with based on a return value from the OS 413 (404), the application program 411 is notified of normal open of the devices. Therefore, the application program 411 starts replay of the music CD or the CD-ROM mounted on the CD drive 14 (410).

In the above-mentioned step 404, when determining that the devices are not fitted with based on the return value from the OS 413, determination as to whether other device (interface card 12, CD drive 14) is fitted with the port (the card slot 3) or not is performed (405). Here, when the other device has already been fitted with, a bay swap instruction for removing the other device is displayed on the display unit 6 (406). This display may be one as shown in FIG. 5(a) described in Embodiment 1.

When recognizing that the above-mentioned other device is removed from the port (card slot 3) through the OS 413 (409), a message for instructing to fit the required device is displayed on the display unit 6 (407).

Then, when recognizing that the required device (interface card 12, CD drive 14) is fitted with (408), the device is opened again (403), and through recognizing again that the device has been fitted with (405), notifies the application program 411 (CD player program) of the fitting.

### INDUSTRIAL APPLICABILITY

The present invention can be employed for a personal computer for connecting an external device such as a modem or a CD-ROM.

What is claimed is:

1. A processing method of an information processor for connecting an external device with a main body of the information processor and performing processing of an application program with respect to the external device, comprising:
connecting the external device to the main body;
determining whether the connected external device has been previously connected with the main body of the information processor.

2. The processing method according to claim 1, further comprising:
interrupting the processing of the application program upon determining the connected external device was not previously connected to the main body of the information processor;
determining whether the external device is still connected to the main body of the information processor; and
identifying a classification of the external device when the determining determines that the external device is still connected to the main body of the information processor.
